(19) United States
(12) Patent Application Publication
(10) Pub. No.: US 2026/0242657 A1
(43) Pub. Date: Aug. 20, 2026

(54) METHOD FOR MODIFYING THE PERMEABILITY OF A SUBTERRANEAN FORMATION AND RELATED TREATMENT FLUID USED IN SAID METHOD

(71) Applicant: ENI S.P.A., Roma (IT)

(72) Inventors: Giuseppe MADDINELLI, San Donato Milanese (MI) (IT); Stefano CARMINATI, San Donato Milanese (MI) (IT); Davide MOSCATELLI, Arese (MI) (IT); Mattia SPONCHIONI, Binasco (MI) (IT); Nicolò MANFREDINI, San Martino Buon Albergo (VR) (IT); Gianmaria GARDONI, Goito (MN) (IT)

(21) Appl. No.: 19/471,173

(22) PCT Filed: Mar. 28, 2024
(86) PCT No.: PCT/IB2024/053042

§ 371 Date: Sep. 30, 2025

(30) Foreign Application Priority Data
Mar. 30, 2023 (IT) 102023000006171

(51) Int. Cl. C09K 8/508; C08F 220/28; E21B 43/16

(52) U.S. Cl. CPC C09K 8/5083; C08F 220/282; E21B 43/16

(57) ABSTRACT

A method for modifying the permeability of a subterranean formation includes the following steps: a. providing a treatment fluid having an aqueous solution of at least one thermo-responsive polymer having at least a lower critical solution temperature (LCST), the thermo-responsive polymer having the reaction product of a component mixture including: (i) a monomer of formula (I), (ii) a radical polymerization initiator, (iii) a chain transfer agent; b. placing the treatment fluid in a zone of the subterranean formation having a temperature T_{f} equal to or higher than the LCST of the thermo-responsive polymer to cause precipitation of the polymer. The treatment fluid used for this purpose is also related.

### CROSS-REFERENCE TO RELATED APPLICATIONS

This application is a 35 U.S.C. § 371 National Stage patent application of PCT/IB2024/053042, filed on 28 Mar. 2024, which claims the benefit of Italian patent application 102023000006171, filed on 30 Mar. 2023, the disclosures of which are incorporated herein by reference in their entirety.

### TECHNICAL FIELD

The present disclosure concerns a method for modifying the permeability of a subterranean formation and the treatment fluid used for this purpose.

The present disclosure can be advantageously used in the oil industry sector, in particular in the so-called improved oil recovery (IOR) or enhanced oil recovery (EOR) operations to modify the permeability of a subterranean formation to displacement fluids, e.g. water or gas, used in the production of hydrocarbon oil and gas.

### BACKGROUND

As known, in the processes of improved recovery of hydrocarbon fluids (oil and gas) from a subterranean formation, the hydrocarbon fluid initially present in the pores of the reservoir rock is brought to the surface by displacement by means of an immiscible fluid (also called displacement fluid), which takes its place. To this end, wells are drilled in the oil field for the injection of the displacement fluid, which are arranged so as to create in the subsoil the most uniform advance front possible to displace the hydrocarbon fluid towards the production well. The displacement fluid is generally water, more frequently saline water, or a more viscous liquid obtained by adding natural or synthetic polymers to water.

The displacement technique through water injections (water flooding) has long been the simplest and most economical technique used to support the production of an oil field and increase the recovery factor of the hydrocarbon fluid.

The quantity of hydrocarbon fluid that can be displaced towards production wells by water injection depends, among other factors, on the degree of heterogeneity of the reservoir rock and on the properties of the hydrocarbon fluid (especially viscosity). In particular, fractures, channels or highly permeable levels (also called “thief zones”) constitute preferential flow paths. The natural tendency of the fluids to flow through the most permeable portions of the reservoir rock implies that, as production progresses, the water injected into the subsoil continues to flow along the thief zones, directly reaching the production wells, without infiltrating (or infiltrating only minimally) into the zones of the reservoir rock in which the hydrocarbon fluid is still present, thus not producing any displacement effect.

In such situations, the production of water can grow to the point of prevailing over that of the hydrocarbon fluid, thus making the production of the latter scarcely or not at all convenient from an economic point of view.

Furthermore, the production of water in combination with the hydrocarbon fluid implies the adoption of specific treatment systems to safely dispose of the water produced or systems for its re-injection into the subsoil. These measures lead to high consumption of energy and raw materials and increase the overall cost of hydrocarbon extraction.

In the state of the art, the problem of unwanted water production and the inadequate efficiency of hydrocarbon recovery by displacement with water is addressed by resorting to the injection into the subsoil of liquid compositions containing chemical compounds capable of modifying permeability characteristics of the subterranean formation. The chemical compounds most used for this purpose are generally polymers, gels or foams. These compounds are also called “blocking agents”. The blocking agents clog the pores of the zones of the formation with the highest permeability, diverting the flow of the displacement fluid towards the zones still rich in hydrocarbon fluid, thus increasing the production capacity of the well.

US 2009/0264321 describes a method for modifying the permeability of a subterranean formation based on the injection in the subsoil of a composition comprising encapsulated expandable polymeric microparticles. Once injected into the subsoil, following an activation event (e.g. temperature or pH variation), the polymeric microparticles emerge from the capsules in which they are enclosed and disperse in the formation, where they swell, absorbing the displacement fluid with which they are in contact. The swelling of the microparticles inside the pores of the formation prevents the flow of the displacement fluid, which is thus diverted towards other zones of the formation. The properties of the aforementioned encapsulated polymeric microparticles, however, cannot be easily modified and thus optimized according to the specific conditions of the formation. Furthermore, the aforementioned microparticles modify the permeability of the formation irreversibly, so that any errors in the injection of the blocking agent cannot be remedied.

Blocking agents based on thermo-responsive polymers are also known in the state of the art. Thermo-responsive polymers are polymers that show a drastic and discontinuous change in chemical-physical properties with temperature. The term “thermo-responsive” is used in the present description with reference to the solubility of the polymer in a solvent. A polymer having a solubility with thermo-responsive characteristics presents a region of immiscibility in the temperature-composition diagram, characterized by at least one reversible phase transition in response to a temperature variation. Generally, in a solution of a thermo-responsive polymer two different phase transition types are observed, each of which is characterized by a particular critical temperature:
A. in a first transition type, the polymers soluble in a given solvent, e.g. water or saline water, become insoluble in the same solvent as the temperature increases; the temperature at which this phase transition occurs is called Lower Critical Solution Temperature (LCST);
B. in a second transition type, polymers insoluble in a given solvent become soluble as the temperature increases; the temperature at which this phase transition occurs is called Upper Critical Solution Temperature (UCST).

Further information on thermo-responsive polymers and their solubility properties can be found, for example, in Chem. Soc. Rev., 2013, 42, 7214, and Polymers 2011, 3, 1215-1242.

US 2012/0264655 describes the use of thermo-responsive polymer-based blocking agents and hydrogels in combination with various treatment fluids for oil extraction operations. The treatment fluids (e.g. drilling fluids, fracturing fluids, etc.) contain a gelling agent formed by a grafted polymer comprising a water-soluble main chain onto which a plurality of side chains having thermo-responsive functional groups are grafted. The polymeric side chains give the polymer a characteristic LCST value, determining the thermo-responsive trend of its solubility in a given solvent as a function of temperature. In one embodiment, the thermo-responsive polymer is formed by a polyacrylic main chain and polyethylene glycol side chains. This polymer is obtained through a reaction a coupling of poly(oxyalkylate) terminated with an amino group and protected with a methyl group (i.e. methoxypolyethylene glycol amine) and polyacrylic acid in the presence of dicyclohexylcarbodiimide.

WO 1995026455 describes a method for controlling permeability in a subterranean formation which comprises injecting an aqueous solution of at least one thermo-responsive polymer into a well to a zone of the formation having a temperature higher than the temperature of the solution in the well. The thermo-responsive polymer has an LCST temperature intermediate between the solution temperature in the well and the zone temperature. Due to the increase in temperature caused by the heat transmitted from the zone to the solution, the thermo-responsive polymer becomes insoluble with consequent precipitation in the formation pores. In accordance with WO 1995026455, the LCST temperature of the thermo-responsive polymer can be adjusted by appropriately choosing the monomers and/or comonomers, their weight ratios or by adding to the polymer solution specific compounds capable of modifying the LCST temperature (e.g. polyethylene glycols, acetone, 2-butoxyethanol). Thermo-responsive polymers are prepared by bulk or suspension polymerization from LCST monomers, such as N-alkylacrylamide, N,N-dialkylacrylamide, diacetone acrylamide, N-acryloylpyrrolidine, vinyl acetate and (meth)acrylate esters (e.g. hydroxypropyl esters).

WO 2020/035838 A1 describes the use of a treatment fluid to control the fluid permeability of a subterranean formation, where the treatment fluid comprises an aqueous solution of a thermo-responsive polymer having a block structure A-B-A′, where A and A′, equal or different from each other, each represent a thermo-responsive oligomeric group and B a hydrophilic oligomeric group of a relatively long length. The aqueous solution, when exposed to a temperature higher than the LCST of the polymer, changes state, becoming a viscous gel that acts as a blocking agent. The LCST temperature of the polymer can be adjusted by changing the composition of the thermo-responsive blocks A and A′. Blocks A and A′ are made up of a hydrophilic portion (e.g. polyoxyethylene chains) and a hydrophobic portion (e.g. (meth)acrylates and (meth)acrylamides). Block B is an oligomer formed, for example, by polyoxyethylene chains or related polymerizable esters (e.g. oligo (ethylene glycol) methyl ether methacrylate, also known by the acronym OEGMA). The method and materials described in WO 2020/035838 A1, although valid and effective, have the disadvantage of requiring the preparation of the thermo-responsive block polymer by RAFT polymerization, which is a technique that is not easy to implement on a large scale and characterized by rather low conversion yields. Furthermore, the viscosity of the thermo-responsive polymer solution is relatively high, making the solution difficult to inject into subterranean formations having relatively low permeability.

### SUMMARY

In consideration of the aforementioned state of the art, the Applicant has therefore set itself on primarily providing a method for controlling the permeability to a fluid of a subterranean formation which overcomes the drawbacks of the prior art.

Within this, a purpose of the present disclosure is to provide a method and fluid for modifying the permeability of a subterranean formation, which utilizes thermo-responsive polymers that can be prepared more easily than prior art thermo-responsive polymers.

A second feature of the present disclosure is to provide a method and a treatment fluid for modifying the permeability of a subsurface formation, in which the LCST temperature of the polymer and the size of the particles formed following precipitation caused by the temperature increase are easily and accurately adjusted according to the needs of use.

The Applicant has now found that these and other advantages, which will be better illustrated in the following description, can be achieved by means of a method for modifying the permeability of a subterranean formation, in which the treatment fluid used comprises an aqueous solution of a thermo-responsive polymer or copolymer comprising at least one monomer of formula (I) as a repeating unit:

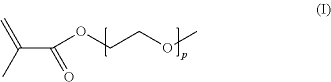

wherein in formula (I), p is an integer in the range 1-20.

It has in fact been observed that this monomer, when subjected to free radical polymerization (radical polymerization) in one single step (random radical polymerization), in the presence of at least one free radical polymerization initiator and at least one chain transfer agent, provides a polymer whose solubility in a given solvent (e.g. water) is thermo-responsive, i.e. the polymer has at least a lower critical solution temperature LCST (lower critical solution temperature) in a given solvent, e.g. water, aqueous solution, saline water.

In particular, the polymer is substantially completely soluble in water or saline water, at temperatures below the LCST (in certain conditions a limited formation of micelles smaller than 100 nm is observed), while it becomes insoluble at the same temperature or higher than the LCST.

In particular, for temperatures equal to or higher than the LCST, the polymer chains separate from the aqueous solution (precipitation), aggregating one with the other and forming aggregates with dimensions in the range of approximately 1-50 μm. The growth of polymer aggregates is favoured by hydrogen bonding interactions between polymer chains as well as by the absorption of water molecules into the polymer structure, which cause swelling of the aggregates and formation of hydrogels.

It is therefore possible to exploit the thermo-responsive behavior of the polymers described herein, by placing an aqueous solution of these polymers in a zone of a subsurface formation having a temperature (T_{f}) higher than the LCST temperature of the polymers, so as to form in situ polymeric aggregates that clog the pores of the formation, modifying its permeability to fluids.

Advantageously, the LCST of the polymers described herein can be adjusted, for example in function of the temperature of the T_{f} formation, by appropriately choosing the length of the polyoxyethylene chain (index p in formula (I)) or by polymerizing the monomer of formula (I) with at least one comonomer having hydrophilic (to increase the LCST) or hydrophobic (to decrease the LCST) characteristics.

Equally advantageously, the dimensions of the polymeric aggregates can also be adjusted according to the needs of use (e.g. permeability characteristics of the subterranean formation to be treated), varying one or more of the monomer concentration, initiator concentration and chain transfer agent concentration in the polymerization mixture, so as to obtain polymer chains having the desired molecular weight.

It was also observed that the dimensions of the final polymeric aggregates also depend on the concentration of the thermo-responsive polymer in the aqueous solution, this concentration being able to be chosen in a wide range of values, without causing a significant increase in the viscosity of the treatment fluid and therefore without negatively affecting its injectability.

Thanks to the low viscosity, the aqueous solution is easily injectable into subsurface formations, even when these have a low permeability to fluids before the treatment according to the present disclosure.

A particular advantage of the thermo-responsive polymers described herein lies in the fact that they can be prepared in a simple and economical way using the conventional free radical polymerization reaction and technique in one single step which, as known, is characterized by relatively high reaction and conversion rates of the monomer, in particular compared to RAFT polymerization.

In fact, RAFT polymerization which belongs to the controlled radical polymerizations, and it is also known as living polymerization, is a multistep polymerization effected by means of subsequent polymerization steps. In the first step, the polymerization of monomers occurs generating a polymer whose terminals are ended by the RAFT agent (which is generally a compound having a dithiocarbonylic functionality with a —C═S— bond reactive with the radical species) which acts as a chain transfer agent (CTA). In the subsequent polymerization steps the polymerization of the monomers occurs in the presence of the polymer obtained in the previous polymerization step since the monomers used in the second step act as chain extender of the polymer previously obtained.

In the single step polymerization (only one step of polymerization) thus the monomers react in the absence of any other polymers.

Moreover, the present radical polymerization in a single step is an uncontrolled chain polymerization effected in the absence of any RAFT agent.

In particular, in the single step radical polymerization all the monomers became part of the polymer or of copolymer simultaneously, thus generating a random polymer in which the repeating units deriving from the monomers are distributed along the chain without any specific order of arrangement.

The thermo-responsive polymers in aggregate form that are obtained at temperatures higher than the LCST have the additional advantage of being able to be made soluble again due to a temperature decrease. The effect of modifying the permeability of a subterranean formation, therefore, is partially or even totally reversible. Polymer aggregates formed in a subterranean formation, for example, can be re-dissolved by injecting a cooling fluid into the formation zone.

In accordance with a first aspect, the present disclosure therefore concerns a method for modifying the permeability of subterranean formation which a comprises:
a. providing a treatment fluid comprising an aqueous solution of at least one thermo-responsive polymer having at least one lower critical solution temperature (LCST), the thermo-responsive polymer comprising the reaction product of one radical polymerization of a component mixture comprising:
(i) a monomer of formula (I),

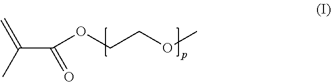

wherein in formula (I), p is an integer in the range 1-20,
(ii) a radical polymerization initiator,
(iii) a chain transfer agent;
b. placing the treatment fluid in a zone of the subterranean formation having a temperature T_{f} equal to or higher than the LCST of the thermo-responsive polymer to cause precipitation of the polymer and modifying the permeability of the subterranean formation.

The radical polymerization of step a. occurs in a single step.

The thermo-responsive polymer resulting from the radical polymerization of step a. is a random polymer.

The radical polymerization of step a. occurs in the absence of any other polymer.

The radical polymerization of step a. typically occurs in the absence of any RAFT agent containing one or more —C═S— bonds reactive with respect to the radical species.

In accordance with a second aspect, the present disclosure concerns a method for recovering a hydrocarbon fluid from a subterranean formation, which comprises:
A. modifying the permeability of a fluid of the subterranean formation by the method according to the first aspect;
B. displacing the hydrocarbon fluid from the subterranean formation treated in phase A to a production well by injecting of a displacement fluid into the formation;
C. recovering the hydrocarbon fluid from the production well.

For the purposes of the present description and the attached claims, the lower critical solution temperature (LCST) of a polymer, in water or in saline water, is that determined with the turbidimetric method described in the examples.

For the purposes of this description and the attached claims, the terms “oligomer” and “polymer” include the terms homopolymer and copolymer, unless explicitly indicated differently or in any case otherwise deducible from the text; that is, oligomers and polymers can be formed by the same repeating unit or by two or more repeating units that are different from each other.

For the purposes of the present disclosure, the number average molecular weight Mn of an oligomer or polymer is that determined by gel permeation chromatography (GPC), using polystyrene as a standard.

For the purposes of the present disclosure, “repeating unit” means the constitutive unit of a polymer or an oligomer; said constitutive unit can correspond to a monomer or to two or more monomers, from which the repeating unit derives following polymerization; said monomer or monomers from which the repetitive unit derives are also referred herein as the “corresponding monomer” of the repeating unit.

Further information about the structure of oligomers and polymers can be found, for example, in Alfred Rudin, Phillip Choi, “The elements of Polymer Science and Engineering”, 3rd edition, Elsevier, 2013.

For the purposes of the present description and the attached claims, the compositions according to the present disclosure may “comprise”, “consist of” or “essentially consist of” the essential and optional components described in the present description and the attached claims.

For the purposes of this description and the attached claims, the expression “consist essentially of” indicates that the composition or component may include additional ingredients, but only to the extent that the additional ingredients do not materially alter the essential characteristics of the composition or component.

The numerical limits and ranges expressed in the present description and in the attached claims also include the numerical value or numerical values mentioned.

### BRIEF DESCRIPTION OF THE DRAWINGS

To better understand the characteristics of the present disclosure, reference will be made to the following figures in the description:

FIG. 1, which shows the differential pressure profile observed during the injection of a treatment fluid according to the disclosure at 25° C. into a sandstone rock sample;

FIG. 2, which shows the permeability to saline water of a sandstone rock treated with a treatment fluid according to the disclosure.

### DETAILED DESCRIPTION OF THE DRAWINGS

As mentioned, the thermo-responsive polymer is a random polymer, obtained by free radical polymerization, in a single step, of a component mixture which includes at least the monomer of formula (I). The monomer of formula (I) is also known commercially by the name OEGMA, an acronym for oligo (ethylene glycol) methyl ether methacrylate.

Preferably, in formula (I) the index p is a number in the range 2-10, preferably 3-6.

Preferably, the monomer of formula (I) has a number average molecular weight (Mn) in the range from 100 to 10,000, more preferably from 100 to 5,000.

Preferably, the thermo-responsive polymer contains the monomer of formula (I) in an amount in the range 40%-100% by weight of the total weight of the monomers of formula (I) and comonomers possibly present, more preferably in the range 50%-100% by weight, even more preferably in the range 60%-95% by weight, even more preferably in the range 80%-95% by weight.

In one embodiment, the monomer of formula (I) is the only polymerizable monomer present in the component mixture used to prepare the thermo-responsive polymer.

In another embodiment, the component mixture also comprises at least one comonomer selected from: hydrophilic comonomer, hydrophobic comonomer and mixtures thereof.

Hydrophilic and hydrophobic comonomers can be employed to regulate the LCST of the thermo-responsive polymer. In particular, hydrophilic comonomers can be used to increase the LCST compared to that of the homopolymer obtained from monomers of formula (I) alone, while hydrophobic comonomers can be used to decrease the LCST.

Examples of hydrophilic comonomers that can be used for the purposes of the present disclosure are: acrylic acid, methacrylic acid, itaconic acid, acrylamido methylpropane sulfonic acid (AMPS).

Examples of hydrophobic comonomers that can be used for the purposes of the present disclosure are: methyl methacrylate (MMA), ethyl acrylate (EA), butyl acrylate (BA), butyl methacrylate (BMA), 2-ethylhexyl acrylate (2EHA), vinyl acetate (VA), styrene (ST), acrylonitrile (ACN).

Preferably, the thermo-responsive polymer contains one or more comonomers in a total quantity in the range 0%-60% by weight with respect to the total weight of the monomers of formula (I) and of the comonomers possibly present in the thermo-responsive polymer, more preferably in the range 0%-50% by weight, even more preferably in the range 5%-40% by weight, even more preferably in the range 5%-20% by weight.

The polymer can be cross-linked, for example by adding at least one cross-linking agent to the component mixture, or not cross-linked. Preferably, the polymer is not cross-linked, i.e. the polymer is obtained from the polymerization of the component mixture in the absence of any added cross-linking agent.

The radical polymerization initiator comprises at least one redox polymerization initiator. The redox initiator is a compound capable of starting a polymerization reaction by generating free radical species through the transfer of an electron from ions or atoms that contain unpaired electrons, followed by the homolytic dissociation of a bond of the acceptor compound. Redox initiators allow to carry out the polymerization reaction under milder conditions compared to polymerization initiated using thermally activated initiators.

Preferably, the redox initiator comprises at least one covalent bond selected from: sulphur-sulphur, oxygen-nitrogen, oxygen-oxygen and combinations thereof. The homolytic breaking of these bonds generates free radical species capable of starting the polymerization reaction.

Preferably, the redox polymerization initiator is a compound selected from: persulfate, superphosphate, peroxide and mixtures thereof. Examples of compounds that can be used for the purposes of the present disclosure are potassium or ammonium salts of persulfate and superphosphate anions, as well as hydrogen peroxide (H₂O₂).

In order to perform its action, the redox initiator is used in combination with a second electron donor compound capable of reacting with the initiator to generate free radicals. An example of a redox couple that can be used as a polymerization initiator is the persulfate/metabisulfite ion couple.

Preferably, the redox initiator is added to the component mixture to produce the polymer in an amount in the range of 0.05% to 15% by weight based on the total weight of the polymerizable monomers, more preferably in the range of 0.5% at 5.0% by weight.

Preferably, the redox initiator is added to the component mixture in an amount in the range of 0.1% to 5.0% by weight based on the overall weight of the monomers, more preferably in the range of 0.2% to 2.0% by weight.

The second electron donor compound is added to the component mixture in an effective amount to react with the redox initiator and generate free radicals.

The chain transfer agent has the function of interrupting the growth of a specific radical polymer chain, without however suppressing the radical activity, but rather transferring it to another chemical species (monomer or other chain) on which the polymerization reaction continues.

Preferably, the chain transfer agent comprises at least one compound selected from: mercapto-alkyl(C₂-C₈)-carboxylic acid, amino-alkyl(C₂-C₈)-carboxylic acid and mixtures thereof.

More preferably, the chain transfer agent comprises at least one compound selected from: mercaptopropionic mercaptobutyric acid, aminopropionic acid, acid, aminobutyric acid and mixtures thereof.

It has been observed that the polymerization of at least one monomer of formula (I) in the presence of the aforementioned redox initiator and chain transfer agent and, optionally, of a comonomer allows to obtain thermo-responsive polymers, whose chains are terminated at both ends by negatively charged species. Without any reference to a particular theory, these charges have a stabilizing effect on the insoluble particles that form consequently to the temperature increase of the polymer solution.

Furthermore, the negative electrical charges on the polymer reduce its interaction with the rock surface of the subterranean formation, thus preventing it from being absorbed by the rock during its passage from the injection point in the subsoil to the zone of the formation whose permeability is desired to be modified. The porosity blocking effect is thus superior, with a consequent reduction in the quantity of polymer to be injected.

In a particularly preferred embodiment, the thermo-responsive polymer comprises a polymer of formula (II)

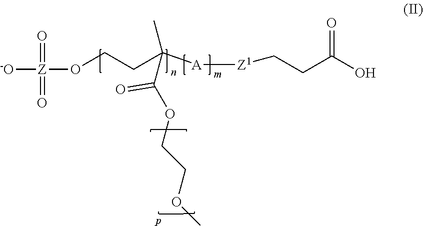

wherein:
A is a comonomer chosen from: hydrophilic comonomer, hydrophobic comonomer and mixtures thereof;
Z and Z¹, equal or different from each other, represent S or P;
n varies from 2 to 500;
m varies from 0 to 500;
p is an integer in the range 1-20.

In one embodiment m is equal to 0.

In one embodiment, the polymer of formula (II) can be obtained by (co) polymerizing the monomer of formula (I) in the presence of a redox initiator selected from a persulfate salt, a superphosphate salt or a combination thereof, and of mercaptopropionic acid as a chain transfer agent.

The thermo-responsive polymers according to the present disclosure preferably have an LCST in the range 0° C.-100° C. Polymers having LCST in this temperature range are suitable for use in subterranean formations generally characterized by a temperature (T_{f}) in the zone whose permeability is to be modified in the range 20° C.-95° C.

Upon exposure to a temperature above the LCST, thermo-responsive polymers dissolved in the treatment fluid precipitate, forming polymer agglomerates, which can absorb water molecules and become hydrogels, varying in size over a relatively wide range. Preferably, the average size of the aggregates is in the range 1-50 μm, this average size being determinable through dynamic light scattering (DLS) measurements.

Advantageously, the thermo-responsive polymers according to the present disclosure can be prepared by free radical polymerization of a component mixture (polymerization mixture) which comprises at least the monomer of formula (I), the redox initiator and the chain transfer agent. Free radical polymerization can be carried out with methods and devices known to a person skilled in the art.

Preferably, the polymerization reaction is carried out by mixing the monomers of formula (I), optional comonomers, the radical polymerization initiator and the chain transfer agent in water. The reaction mixture is preferably reacted at a temperature in the range of 40° C.-95° C. and atmospheric pressure.

Free radical polymerization, in addition to being carried out in relatively mild conditions compared to other types of polymerization, in particular RAFT polymerization, has high conversion yields of the polymerizable monomers, which are also obtained in relatively short times. For example, under the aforementioned conditions, it is possible to obtain a conversion yield of up to 99.9% after 4 hours from the start of the reaction, 98% of the conversion however being achieved after only 2 hours.

To modify the permeability of a subterranean formation, the thermo-responsive polymers according to the present disclosure are introduced into the zone of the formation whose fluid permeability is desired to be modified (insolubility zone) in the form of an aqueous treatment fluid. In particular, the treatment fluid comprises an aqueous solution of the thermo-responsive polymer. It is also possible to use a mixture of two or more thermo-responsive polymers having different LCST temperatures.

Preferably, the concentration of the thermo-responsive polymer in the aqueous solution is in the range of 0.1%-10% by weight, more preferably in the range of 0.5% to 5% by weight, relative to the weight of the aqueous solution.

To prepare the aqueous solution it is possible to use water, sea water or synthetic saline water.

Advantageously, the treatment fluid comprising the thermo-responsive polymer can be used to control the permeability of a subterranean formation during an oil extraction activity.

For the purposes of the present disclosure, subterranean formation means a zone below the earth surface, including seabed surfaces.

The method for controlling the fluid permeability of a subterranean formation according to the present disclosure can be applied both before starting the extraction of the hydrocarbon fluid from the subterranean formation and when the extraction well is already in production.

The method according to the present disclosure can be advantageously applied to so-called “mature” extraction wells, i.e., to wells that have reached the limit of production capacity, which are characterized by the extraction of significant quantities of water in association with hydrocarbon oil or gas.

The placement of the treatment fluid for permeability control in a subterranean formation can be achieved with equipment and techniques known from the oil production industry.

The placement, for example, can be carried out by injecting the treatment fluid through the hydrocarbon fluid production well and/or through other wells generally present in an oil field, such as wells for the injection of steam in the subsoil, water or other displacement fluids (so-called injector wells).

On the basis of the criteria and with the preparation methods set out above, a person skilled in the art can select the treatment fluid comprising the thermo-responsive polymer in such a way that said polymer has an LCST greater than the temperature of the treatment fluid inside the well (injection temperature) and lower than the temperature of the zone of the formation whose permeability (T_{f}) is to be modified.

In particular, the method according to the present disclosure can be used in the context of secondary and tertiary activities for the recovery of a hydrocarbon oil, both in water blocking interventions (water shut-off treatment) and in the conformation treatments of the subterranean formation (conformance control treatment).

In the case of water shut-off processes, the formation zone having a temperature T_{f} higher than the LCST of the polymer is generally a zone adjacent to that on which a production well is located. The conversion of the polymer dissolved in the treatment fluid into an insoluble polymer due to the temperature increase of the polymer (from the injection temperature to the formation temperature T_{f}) causes formation of particles capable of clogging the pores of the formation, with consequent blockage or reduction of fluid permeability.

Due to this change in permeability, the subsequently injected displacement fluid will be diverted from the zone of the formation treated with the polymer towards adjacent zones with greater permeability, where it will be able to more effectively displace any hydrocarbon fluid present towards the production well.

The displacement fluid can be water, sea water, synthetic saline water, or a water-based fluid with a higher density than water, for example due to the presence of viscosifying polymers, natural or synthetic.

In the case of improved or assisted recovery processes, the zone of the formation to be treated may be a thief zone of the formation, i.e., a zone whose relatively high permeability is such as to cause a significant loss of the injected displacement fluid. In this case, the polymer in the form of polymeric aggregates or hydrogels, which is formed in situ due to the effect of the temperature rise from the injection temperature to that of the treated formation zone, causes the reduction of the permeability of the bleeding zone with consequent reduction of the displacement fluid loss and increase in the recovery efficiency of the hydrocarbon fluid.

The amount of treatment fluid comprising the thermo-responsive polymer to be placed in the subterranean formation can vary widely depending on the specific geological conformation of the formation. This quantity can be easily established by a person skilled in the field on the basis of the geological characteristics of the formation and simple routine experimental tests.

The following embodiments are provided for the sole purpose of illustrating the present disclosure and must not be understood as limiting the scope of protection defined by the attached claims.

### EXAMPLES

### 1. Determination of LCST

For the purposes of the present disclosure, the lower critical solution temperature (LCST) of a polymer is determined by means of the turbidimetry technique, measuring the optical transmittance of an aqueous solution of 0.2% by weight of the investigated polymer, at ambient pressure. Transmittance measurements are carried out on the sample maintained at different temperatures. By plotting the recorded percentage transmittance against the corresponding sample temperature, a sigmoid curve is obtained. The temperature at the inflection point of the curve is considered the LCST of the polymer.

### 2. Preparation of Thermo-Responsive Polymers

A series of thermo-responsive polymers in accordance with the present disclosure was prepared as described below, using the following components:
monomer of formula (I) with p=4, Mn=300 Da (OEGMA300);
potassium persulfate (oxidising redox initiator);
sodium metabisulfite (reducing redox initiator)
mercaptopropionic acid (chain transfer agent)
mixture of hydrophilic comonomers: potassium 3-sulfopropyl methacrylate (SPMAK) and 2-hydroxymethyl methacrylate (HEMA).

The synthesis was carried out by dissolving 15.79 g of OEGMA300, 0.158 g of HEMA and 0.316 g of SPMAK in 300 mL of distilled water. The reaction mixture was inertized by flushing nitrogen for 30 minutes and brought to a temperature of 58° C. Subsequently, 0.47 g of potassium persulfate, 0.35 g of metabisulfite and 0.016 g of mercaptopropionic acid dissolved in a small quantity of water were added to the reaction and the mixture was left to react for 5 hours at a temperature of 70° C. Finally, the polymers in aqueous solution were diluted to the mass concentration necessary for subsequent experiments.

The LCST temperature of the prepared polymers is reported in Table 2.

### 3. Preparation of the Treatment Fluid.

The polymers prepared as described in the previous point 2 were formulated as aqueous solutions, using synthetic saline water having the composition shown in Table 1 (density at 70° C.=0.9465 kg/L; viscosity at 70° C.=0.4058 cP).

TABLE 1
Saline water composition

| | Concentration |
|---|---|
| Compound | (g/L) |
| NaCl | 22.0 |
| MgCl₂ (6H₂O) | 9.7 |
| Na₂SO₄ (anhydrous ) | 3.7 |
| CaCl₂ (anhydrous) | 1.0 |
| KCl | 0.65 |
| NaHCO₃ | 0.2 |
| H₃BO₄ | 0.023 |
| Total | 37.273 |

Table 2 shows the compositions of the polymeric solutions tested.

TABLE 2
Composition of treatment fluids (polymeric solutions)

| | Concentration | | | |
|---|---|---|---|---|
| | of the solution | LCST | Dₙᵢ | D_{nf} |
| Sample n. | [wt %] | [° C.] | [nm] | [nm] |
| DNM13 | 2 | 64 | 30 | 1500 |
| DNM14 | 2 | 64 | 50 | 2000 |
| DNM15 | 3 | 65 | 40 | 4200 |
| DNM18 | 2 | 65 | 10 | 4000 |
| DNM19 | 2 | 65 | 20 | 10000 |

In Table 2, Dₙᵢ values indicate the average size of polymer micelles observed in the solution maintained at a temperature at least 3° C. lower than the LCST of the polymer.

The D_{nf} values indicate the average size of the polymeric aggregates generated in the solution maintained at a temperature at least 2° C. higher than the LCST of the polymer.

Dₙᵢ and D_{nf} values were determined by Dynamic Light Scattering (DLS).

### 4. Permeability Modification Tests on Berea Sandstone

The effectiveness of polymeric solutions as treatment fluid to modify the permeability of a subterranean formation was experimentally verified on samples of Berea sandstone, in the following way.

Sandstone rock samples of the Berea sandstone type were prepared (in the form of a cylindrical core of 10.00 cm length and 2.46 cm diameter) having approximately the same permeability (k_{gas} ca. 78 mD). Each sample was used to test a single polymer solution.

Fluid permeability measurements were carried out on each sample, using gas (nitrogen), the polymeric solutions of Table 2 and the saline water of Table 1 (without thermo-responsive polymers) as the reference fluid.

The cylindrical core housed in a sample holder was placed inside a temperature-controlled oven. The measurement system included, in addition to the aforementioned oven, a pumps system for injecting fluids into the core at pre-established flow rate values and devices for measuring the flow rates of the fluids. A containment overpressure (nitrogen) of 50 bar (in addition to the internal pressure) was applied to the core to avoid the effects related to the compressibility of the sample during the injection of the fluids. During fluxing of the fluids in the sample, the load losses between inflow and outflow of the fluid from the sample were measured by means of electronic transducers.

Initially, the pore volume and porosity of the sand sample were determined by first placing the sample under vacuum and then flowing nitrogen until the outlet flow stabilized.

Subsequently, the permeability of the sample was measured at 25° C., by flowing the reference fluid consisting of saline water.

Subsequently, the treatment fluid consisting of the polymer solution was injected at 25° C. until the core was saturated (obtained by generally flowing a volume of solution equal to approximately 4-5 times the porous volume).

The sample saturated with the polymer solution was then conditioned at 75° C. overnight to cause insolubility of the thermo-responsive polymer and consequent modification of the sand permeability.

At the end of the conditioning, saline water was injected again into the sample kept at 75° C. to determine the change in permeability following the treatment with the polymer solution.

The saline water permeability measurement was repeated after cooling the sample to a temperature of 25° C.

In permeability measurements, the permeability value of a sample was determined by measuring the load loss once the flow of the injected fluid exiting the sample stabilized.

The change in permeability produced by the treatment with the tested polymer solutions was evaluated using the resistance factor Fᵣ and the residual resistance factor Fᵣᵣ.

The resistance factor Fᵣ provides an indication of the relative mobility of the polymer solution within the sample compared to the mobility of saline water alone in the same sample.

The Fᵣ factor is calculated with the following equation:

Fᵣ=ΔP_{g}/ΔP_{w}
wherein ΔP_{g} is the load loss observed for the injection at a given flow speed of the polymer solution and ΔP_{w} is the load loss observed for injection at the same flow speed as the saline solution.

The residual resistance factor Err provides a measure of the decrease in the relative mobility of the reference fluid (saline water) in the sample following treatment of the sample with the treatment fluid compared to the mobility of the same reference fluid before treatment of the sample with the treatment fluid.

The Fᵣᵣ factor is calculated with the following equation:

$${F}_{rr} = {( Δ {P}_{w} )}_{after} / {( Δ {P}_{w} )}_{before}$$

wherein (ΔP_{w})_{after} is the load loss observed for injection at a given flow rate of saline water after treatment with the polymer solution and (ΔP_{w})_{before} is the load loss observed for injection at the same flow rate as the saline solution before treatment.

Higher values of the parameters Fᵣ and Fᵣᵣ indicate a higher resistance of the sample to the passage of a fluid.

The results of the permeability tests are shown in Table 3.

TABLE 3
Permeability test results

| | | | | Fᵣ |
|---|---|---|---|---|
| | Kᵢₙ | K_{fin} | K_{rEd} | (polymeric |
| Sample n. | [mD] | [mD] | [K_{fin}/Kᵢₙ] | solution) |
| DNM13 | 32.63 | 12.7 | 0.38 | 6.5 |
| DNM14 | 34.4 | 14.6 | 0.42 | 3.1 |
| DNM15 | 40.68 | 3.785 | 0.09 | 4.2 |
| DNM18 | 46.6 | 8.61 | 0.18 | 1.8 |
| DNM19 | 45.65 | 8.61 | 0.18 | 5.3 |

Kᵢₙ = permeability of saline water at 75° C. before treatment with the polymer solution;
K_{fin} = permeability of saline water at 75° C. after treatment with the polymer solution
Fᵣ = resistance factor at 75° C. observed for the injection of the polymer solution

The tested sandstone rock samples were characterized by low permeability (K_{gas} ca. 78 mD), a characteristic that generally makes the injection of a treatment fluid very difficult.

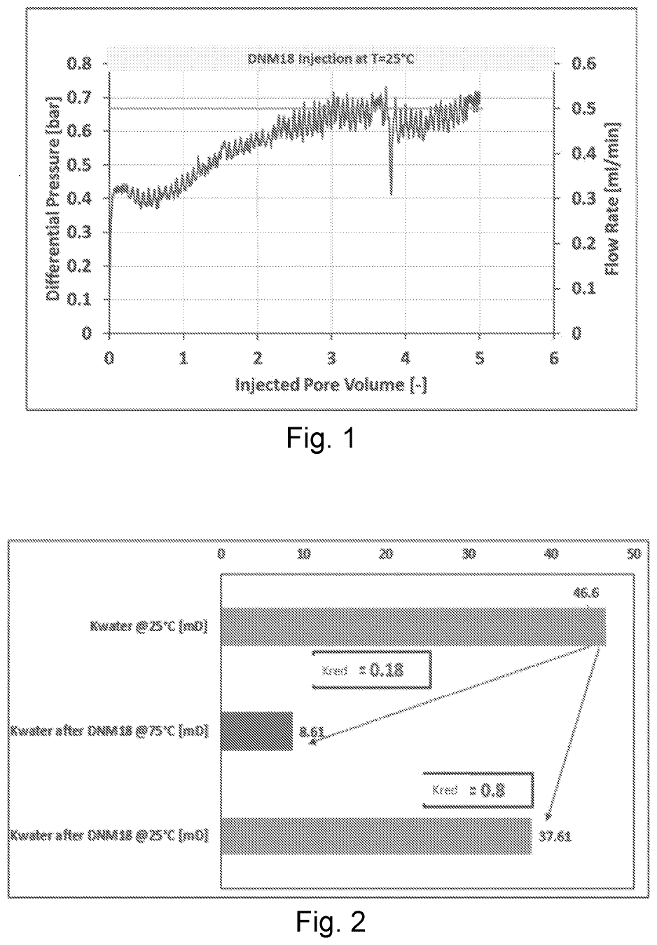

The polymer solutions according to the present disclosure, however, showed high injectability into sandstone rock. FIG. 1, for example, shows the differential pressure profile observed during the injection of the DNM18 polymer solution at 25° C. This profile shows that it was possible to achieve a stable flow rate of around 0.5 ml/min with a load loss of only approx. 0.7 bar.

The data in Table 2 also shows that all the polymeric solutions tested have a fair or excellent injectability into the sandstone rock, the Fᵣ value observed always being below 10.

In particular, the DNM18 sample showed an Fᵣ value of 1.8, which indicates excellent injectability of the polymer solution in this type of low permeability sandstone rock.

Following conditioning of the sample overnight, the permeability of the rock at 75° C. was remarkably reduced due to insolubility of the polymer in the porous rock matrix. The precipitation of the polymer aggregates caused a reduction in permeability of up to 9% of the initial one in the case of the DNM15 sample and up to 42% in the case of the DNM14 sample.

FIG. 2 schematically reports the absolute permeability values of Table 3 for the DNM18 sample, which were observed at 25° C. and 75° C., before and after treatment.

The graph shows that the permeability of the rock was significantly reduced (Fᵣᵣ=2.1) as a result of the treatment at 75° C. with the polymer solution (K_{fin}=8.61 mD).

The graph also shows that the permeability reduction effect can be almost completely reversed by cooling the sample down to the initial temperature of 25° C.

The examples demonstrate the effectiveness of the present disclosure in modifying, even reversibly, the fluid permeability of a subterranean formation.

1. A method for modifying the permeability of a subterranean formation, the method including the following steps:
a. providing a treatment fluid comprising an aqueous solution of at least one thermo-responsive polymer having at least one lower critical solution temperature (LCST), the thermo-responsive polymer comprising the reaction product of a radical polymerization of a component mixture comprising: (i) a monomer of formula (I), 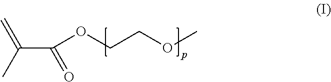
wherein in formula (I), p is an integer in the range 1-20,
(ii) a radical polymerization initiator,
(iii) a chain transfer agent; and
b. placing the treatment fluid in a zone of the subterranean formation having a temperature T_{f} equal to or higher than the LCST of the thermo-responsive polymer to cause precipitation of the polymer.

2. The method according to claim 1, wherein the radical polymerization initiator comprises at least one redox polymerization initiator comprising at least one covalent bond selected from: oxygen-oxygen, oxygen-nitrogen, sulfur-sulfur and combinations thereof.

3. The method according to claim 2, wherein the at least one redox polymerization initiator comprises at least one compound selected from: persulphate, perphosphate, peroxide and mixtures thereof.

4. The method according to claim 1, wherein the radical polymerization initiator comprises at least one electron donor compound capable of reacting with the redox initiator to generate free radicals, said electron donor compound being preferably metabisulfite.

5. The method according to claim 1, wherein the chain transfer agent comprises at least one compound selected from: mercapto-alkyl(C₂-C₈)-carboxylic acid, amino-alkyl(C₂-C₈)-carboxylic acid and mixtures thereof.

6. The method according to claim 5, wherein the chain transfer agent comprises at least one compound selected from: mercaptopropionic acid, mercaptobutyric acid, aminopropionic acid, aminobutyric acid and mixtures thereof.

7. The method according to claim 1, wherein in formula (I) p is a number in the range 2-10.

8. The method according to claim 1, wherein the component mixture comprises at least one comonomer selected from: hydrophilic comonomer, hydrophobic comonomer and mixtures thereof, said comonomers being preferably selected from:
hydrophilic comonomer: acrylic acid, methacrylic acid, itaconic acid, acrylamide methylpropane sulfonic acid (AMPS); and
hydrophobic comonomer: methyl methacrylate (MMA), ethyl acrylate (EA), butyl acrylate (BA), butyl methacrylate (BMA), 2-ethylhexyl acrylate (2EHA), vinyl acetate (VA), styrene (ST), acrylonitrile (ACN).

9. The method according to claim 1, wherein the thermo-responsive polymer comprises a polymer of formula (II) 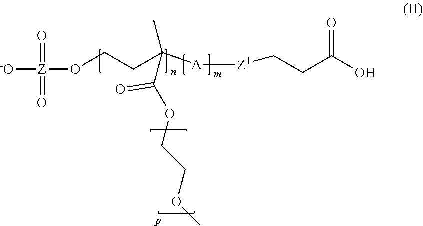
wherein:
A is a comonomer selected from: hydrophilic comonomer, hydrophobic comonomer and mixtures thereof;
Z and Z¹, identical or different from each other, represent S or P;
n ranges from 2 to 500;
m ranges from 0 to 500;
p is an integer in the range 1-20.

10. The method according to claim 1, wherein said component mixture comprises:
(i) a monomer of formula (I), 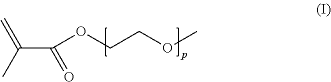
wherein in formula (I), p is an integer in the range 2-10,
(ii) a radical polymerization initiator,
(iii) a chain transfer agent;

11. A method for recovering a hydrocarbon fluid from a subterranean formation, which includes the following steps:
A. modifying the permeability of the subterranean formation to a fluid by the method according to claim 1;
B. displacing the hydrocarbon fluid from the subterranean formation treated in step A in a production well by injection of a displacement fluid into the formation; and
C. recovering the hydrocarbon fluid from the production well.

12. The method of recovering a hydrocarbon fluid from a subterranean formation according to claim 11, wherein step A limits the infiltration of water into a hydrocarbon fluid extraction well.

13. The method for recovering a hydrocarbon fluid from a subterranean formation according to claim 11, wherein in step A the permeability of a thief zone is modified.

14. The method according to claim 1, wherein the thermo-responsive polymer of step a. is a random polymer.

15. A treatment fluid for modifying the fluid permeability of a subterranean formation, said fluid comprising an aqueous solution of at least one thermo-responsive polymer having at least one lower critical solution temperature (LCST), the thermo-responsive polymer comprising the reaction product of a radical polymerization of a component mixture comprising:
(i) a monomer of formula (I), 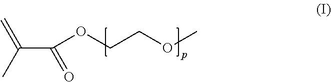
wherein in formula (I), p is an integer in the range 1-20,
(ii) a radical polymerization initiator,
(iii) a chain transfer agent.
